(19) United States
(12) Patent Application Publication
(10) Pub. No.: US 2025/0260258 A1
(43) Pub. Date: Aug. 14, 2025

(54) CHARGING CONTROL METHOD AND APPARATUS, SOLAR CHARGING CONTROLLER, AND STORAGE MEDIUM

(71) Applicant: SHENZHEN HELLO TECH ENERGY CO., LTD, Shenzhen, Guangdong (CN)

(72) Inventors: Jiping WANG, Shenzhen (CN); Gaosong SHEN, Shenzhen (CN); Zijun GONG, Shenzhen (CN); Genghui XIE, Shenzhen (CN); Zhongwei SUN, Shenzhen (CN)

(21) Appl. No.: 19/192,388

(22) Filed: Apr. 29, 2025

Related U.S. Application Data
(63) Continuation of application No. PCT/CN2023/109625, filed on Jul. 27, 2023.

(30) Foreign Application Priority Data
Nov. 3, 2022 (CN) 202211365325. 0

(51) Int. Cl. H02J 7/35; H02J 7/00

(52) U.S. Cl. CPC H02J 7/35; H02J 7/00714; H02J 7/007182

(57) ABSTRACT

Provided are a charging control method and apparatus, a solar charging controller, and a storage medium. The charging control method includes: detecting an initial open-circuit voltage of the power input source, and determining an initial charging strategy corresponding to the power input source based on the initial open-circuit voltage of the power input source; detecting, subsequent to the power input source executing the initial charging strategy, input source current information of the power input source and determining whether to adjust the initial charging strategy based on the input source current information; and detecting, in response to determining to adjust the initial charging strategy, a current open-circuit voltage of the power input source, and generating a current charging strategy corresponding to the current open-circuit voltage based on the current open-circuit voltage, and controlling the power input source to execute the current charging strategy.

This application is a continuation of International Application No. PCT/CN2023/109625 filed on Jul. 27, 2023, which claims priority to Chinese Patent Application No. 202211365325.0, filed on Nov. 3, 2022, the entire content of which is incorporated herein by reference.

### FIELD

The present disclosure relates to the field of solar charging control technologies, and in particular, to a charging control method and apparatus, a solar charging controller, and a storage medium.

### BACKGROUND

A solar cell is an apparatus that converts light energy into electrical energy and is capable of outputting a voltage and current under an irradiance that meets a predetermined condition. The solar cell is capable of producing electrical energy but unable to store the produced electrical energy. However, the electrical energy produced by the solar cell may be stored in a storage battery by charging the storage battery.

In order to improve charging efficiency of a solar charging system, some solar charging systems may identify a type of a power input source (such as one solar cell string or a plurality of solar cell strings) according to a voltage of the power input source, and set an input voltage of the solar charging system close to a maximum power point of the power input source according to the type of the power input source type, to increase the utilization rate of the solar cell. However, referring to FIG. 1 and FIG. 2, under a low irradiance, output voltages of one solar cell string and two solar cell strings, that is, power input sources of different types, are all relatively low. In this case, the output voltages are close to each other, i.e., open-circuit voltages of one solar cell string and two solar cell strings in FIG. 1 and FIG. 2 are both 16 volts (V). As can be seen, determining the type of the power input source through only the input voltage causes a problem of inaccurate determination of the type of the power input source, resulting in low charging efficiency of a solar cell panel.

### SUMMARY

The present disclosure provides a charging control method and apparatus, a solar charging controller, and a storage medium, to solve a problem where a power input source type is incorrectly determined under low irradiance, thus causing low charging efficiency of a power input source when the irradiance increases.

According to an aspect of the present disclosure, a charging control method is provided. The charging control method includes: detecting an initial open-circuit voltage of a power input source, and determining an initial charging strategy corresponding to the power input source based on the initial open-circuit voltage of the power input source; detecting, subsequent to the power input source executing the initial charging strategy, input source current information of the power input source and determining whether to adjust the initial charging strategy based on the input source current information; detecting, in response to determining to adjust the initial charging strategy, a current open-circuit voltage of the power input source, and generating a current charging strategy corresponding to the current open-circuit voltage based on the current open-circuit voltage; and controlling the power input source to execute the current charging strategy.

According to another aspect of the present disclosure, a charging control apparatus is provided. The charging control apparatus includes: an initial charging strategy determination module configured to detect an initial open-circuit voltage of a power input source, and determine an initial charging strategy corresponding to the power input source based on the initial open-circuit voltage of the power input source; an initial charging strategy adjustment module configured to detect, subsequent to the power input source executing the initial charging strategy, input source current information of the power input source and determine whether to adjust the initial charging strategy based on the input source current information; and a current charging strategy execution module configured to detect, in response to determining to adjust the initial charging strategy, a current open-circuit voltage of the power input source, and generate a current charging strategy corresponding to the current open-circuit voltage based on the current open-circuit voltage, and control the power input source to execute the current charging strategy.

According to another aspect of the present disclosure, a solar charging controller is provided. The solar charging controller includes: at least one processor; and a memory in a communication connection with the at least one processor. The memory stores a computer program executable by the at least one processor. The computer program is executed by the at least one processor to enable the at least one processor to perform the charging control method as described in any one of embodiments of the present disclosure.

According to another aspect of the present disclosure, a computer-readable storage medium is provided. The computer-readable storage medium stores a computer instruction. The computer instruction is configured to cause the processor, when executed, to implement the charging control method as described in any one of the embodiments of the present disclosure.

### BRIEF DESCRIPTION OF THE DRAWINGS

Drawings used in the description of the embodiments are described below. The drawings as described below are merely some embodiments of the present disclosure. Based on these drawings, other drawings can be obtained by those skilled in the art without creative effort.

FIG. 1 is a schematic diagram of a PV curve of one solar cell string under an irradiance of 70 W/M² and with an open-circuit voltage of 16V according to a background technology of the present disclosure.

FIG. 2 is a schematic diagram of a PV curve of two of solar cell strings under an irradiance of 8 W/M² and with an open-circuit voltage of 16V according to a background art of the present disclosure.

FIG. 3 is a flowchart of a charging control method according to a first embodiment of the present disclosure.

FIG. 4 is a flowchart of a charging control method according to a second embodiment of the present disclosure.

FIG. 5 is a schematic diagram of a PV curve of one solar cell string under an irradiance of 150 W/M², i.e., Imp=2.1 A, and with an open-circuit voltage of 19.3V according to an embodiment of the present disclosure.

FIG. 6 is a schematic diagram of a PV curve of two solar cell strings under an irradiance of 150 W/M², i.e., Imp=2.1 A, and with an open-circuit voltage of 38.6V according to an embodiment of the present disclosure.

FIG. 7 is a flowchart of a charging control method according to a third embodiment of the present disclosure.

FIG. 8 is a schematic structural diagram of a charging control apparatus according to a fourth embodiment of the present disclosure.

FIG. 9 is a schematic structural diagram of a solar charging controller implementing a charging control method according to the embodiments of the present disclosure.

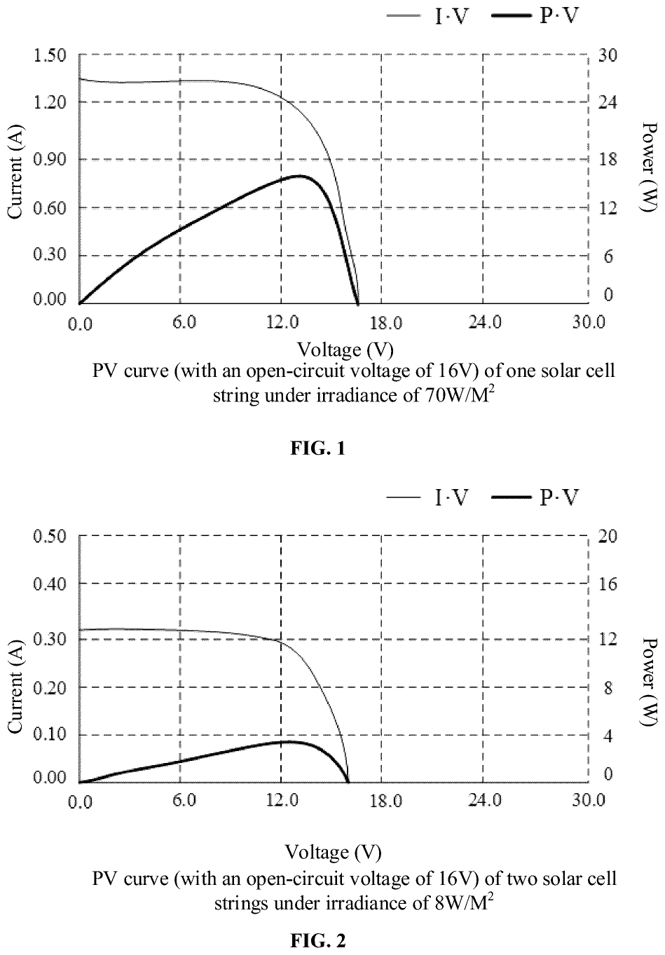

### DETAILED DESCRIPTION

Embodiments of the present disclosure will be described below in combination with accompanying drawings of the embodiments of the present disclosure. The embodiments described below are only a part of the embodiments of the present disclosure, rather than all of the embodiments. On a basis of the embodiments in the present disclosure, all other embodiments obtained by a person skilled in the art without creative labor shall fall within the protection scope of the present disclosure.

It should be noted that terms such as “first”, and “second” in detailed description of the embodiments, the claims of the present disclosure, and the accompanying drawings, are used to distinguish between similar objects, rather than to describe a particular order or sequence. It should be understood that the data used in this way can be interchanged with each other under appropriate circumstances, such that the embodiments of the present disclosure described herein can be implemented in a sequence other than those illustrated in the figures or described in the present disclosure. In addition, terms “include”, “have”, and any variations thereof are intended to cover non-exclusive inclusions. For example, a process, method, system, product, or device that includes a series of steps or units is not necessarily limited to those clearly listed steps or units, but may also include other steps or units that are not clearly listed or are inherent to the process, method, product, or device.

### First Embodiment

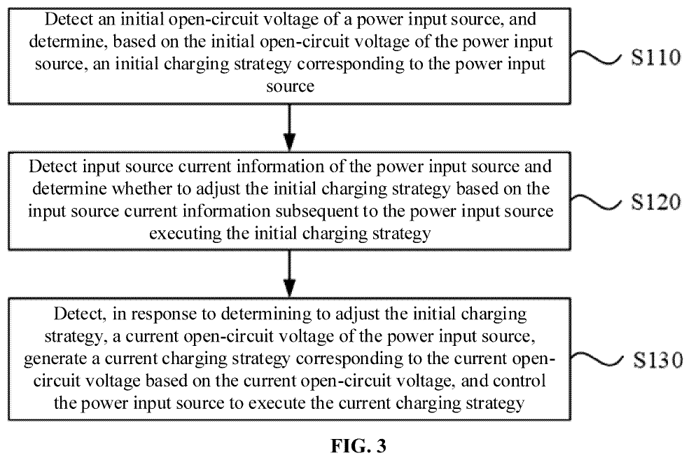

FIG. 3 is a flowchart of a charging control method according to a first embodiment of the present disclosure. This embodiment is applicable to a situation where automatic determination of a power input source type is performed for solar charging control. This charging control method is executable by a charging control apparatus. The charging control apparatus may be implemented in the form of hardware and/or software, and may be configured in a solar charging controller. As shown in FIG. 3, the charging control method includes operations at blocks S110 to S130.

At block S110, an initial open-circuit voltage of a power input source is detected, and an initial charging strategy corresponding to the power input source is determined based on the initial open-circuit voltage of the power input source.

The power input sources may be of different types such as one string of solar cell panels or a system including a plurality of strings of solar cell panels.

The solar charging controller in this embodiment may perform simultaneous detection on the at least one power input source, to determine the power input source type of each power input source in real time, i.e., determine that each power input source is the one string of solar cell panels or the system including a plurality of strings of solar cell panels.

In an embodiment, when the power input source is connected to a corresponding energy storage apparatus to charge the energy storage apparatus, the solar charging controller obtains the initial open-circuit voltage of each power input source. The energy storage apparatus is an apparatus capable of storing electrical energy. In an embodiment, the energy storage apparatus may be a battery system such as a lead-acid battery, a lithium battery, or other apparatuses.

It is known that power input sources of one or more power input source types have respective open-circuit voltage ranges under a given irradiance temperature condition.

For example, V1, V2, . . . , Vn, and Vn+1 are specific voltages of a solar charging system. A first power input source, a second power input source, . . . , and an Nth power input source are correspondingly power input sources of different power input source types. The open-circuit voltage range of the power input source of each power input source type under the given irradiance temperature condition may be set as follows. A voltage range from V1 to V2 is set as the open-circuit voltage range of the first power input source under the given irradiance temperature condition. A voltage range from V2 to V3 is set as the open-circuit voltage range of the second power input source under the given irradiance temperature condition. Analogously, a voltage range from Vn to Vn+1 is set as the open-circuit voltage range of the Nth power input source under the given irradiance temperature condition.

It should be noted that the present disclosure is on the basis that the solar cell strings are of the same specification and that respective open-circuit voltage ranges of the solar charging system does not overlap with each other.

On the above basis, when the solar charging controller detects the initial open-circuit voltage of the power input source, the solar charging controller determines the open-circuit voltage range within which the initial open-circuit voltage of the power input source is located, and determines the power input source type corresponding to the power input source.

After the power input source type corresponding to each power input source is determined, a corresponding initial charging strategy is determined based on the power input source type. The solar charging controller controls the solar charging system to execute the initial charging strategy and start charging until charging of the solar charging system ends.

A minimum input voltage of the power input source is determined based on the power input source type, which is determined based on the initial open-circuit voltage of each power input source. The initial charging strategy is a charging strategy that the power input source performs a charging operation at the minimum input voltage.

On the basis of the above embodiment, in response to the initial open-circuit voltage of the power input source being not within the open-circuit voltage range of any one of one or more power input source types under the given irradiance temperature condition, the open-circuit voltage of the power input source is re-detected, i.e., an updated open-circuit voltage of the power input source is detected, and it is re-determined whether the updated open-circuit voltage is within the open-circuit voltage range of any one of the one or more power input source types under the given irradiance temperature condition based on the updated open-circuit voltage. It can be understood that the solar charging system does not execute any charging logic in this process.

At block S120, subsequent to the power input source executing the initial charging strategy, input source current information of the power input source is detected, and it is determined whether to adjust the initial charging strategy based on the input source current information.

In an embodiment, after each power input source separately executes the corresponding initial charging strategy, the solar charging system is controlled by the solar charging controller to continuously execute the initial charging strategy for a predetermined time length. The predetermined time length for which the initial charging strategy is continuously executed may be selected and set by a person skilled in the art based on actual situations. In an embodiment, the predetermined time length for continuously executing the initial charging strategy may be a few seconds or a few tens of seconds. Setting a shorter charging strategy time length allows to quickly re-determine whether the current charging strategy is appropriate, which is beneficial to timely adjustment of the charging strategy based on the power input source type.

After the solar charging system is controlled by the solar charging controller to continuously execute the initial charging strategy for the predetermined time length, the input source current information of the power input source is detected, i.e., input current information of the solar charging system is detected. Then, it is determined whether to adjust the initial charging strategy based on the input source current information.

On the above basis, in response to an input current of the input source current information of the power input source detected for the first time being greater than an input current threshold, it is considered that the initial open-circuit voltage of the power input source is sufficient to determine the power input source type corresponding to the power input source, i.e., the power input source type corresponding to the power input source determined based on the block S110, and the corresponding initial charging strategy determined based on the corresponding power input source type are both correct. In this case, the solar charging system is controlled by the solar charging controller to continue to execute the initial charging strategy corresponding to the power input source until the charging of the solar charging system ends.

Correspondingly, in response to the input current of the input source current information of the power input source detected for the first time being smaller than or equal to the input current threshold, the power input source type corresponding to the power input source determined based on the initial open-circuit voltage of the power input source is considered to be unreliable. At this time, within a predetermined time range, the power input source is controlled to continue to execute the initial charging strategy. Thereafter, it is re-determined whether the detected input current of the input source current information of the power input source is greater than the input current threshold.

On the above basis, the input current of the input source current information of the power input source continues to be continuously detected, and in response to detecting that the input current of the input source current information of the power input source is greater than the input current threshold, it is determined to adjust the initial charging strategy, and the power input source is controlled to be in a no-load state.

It can be understood that in response to the input current of the input source current information of the power input source, which continues to be continuously detected, is smaller than or equal to the input current threshold, it is determined not to adjust the initial charging strategy.

At block S130, in response to determining to adjust the initial charging strategy, a current open-circuit voltage of the power input source is detected, a current charging strategy corresponding to the current open-circuit voltage is generated based on the current open-circuit voltage, and the power input source is controlled to execute the current charging strategy.

In an embodiment, after it is determined to adjust the initial charging strategy, the solar charging system stops charging the energy storage system, causing the power input source to be in the no-load state, i.e., the solar charging system is in the no-load state, and the open-circuit voltage of the power input source is re-detected.

On the above basis, the current open-circuit voltage of the power input source is detected, and a power input source type corresponding to the current open-circuit voltage is determined based on an open-circuit voltage range within which the current open-circuit voltage is located. Moreover, the current charging strategy corresponding to the current open-circuit voltage is generated based on the power input source type corresponding to the current open-circuit voltage. The solar charging system is controlled by the solar charging controller to execute the current charging strategy and start charging until the charging of the solar charging system ends.

On the basis of the above embodiment, after the current open-circuit voltage of the power input source is detected, in response to the current open-circuit voltage being not within the open-circuit voltage range corresponding to any one of one or more power input source types under the given irradiance temperature condition, the updated open-circuit voltage of the power input source is re-detected, i.e., the operation at block S110 is performed to re-detect the open-circuit voltage of the power input source.

In the embodiments of the present disclosure, the initial open-circuit voltage of the at least one power input source is detected, and the initial charging strategy corresponding to the power input source is determined based on the initial open-circuit voltage corresponding to the power input source. After the power input source executes the initial charging strategy, the input source current information of the power input source is detected, and it is determined whether to adjust the initial charging strategy based on the input source current information. When it is determined to adjust the initial charging strategy, the current open-circuit voltage of the power input source is detected, the current charging strategy corresponding to the current open-circuit voltage is generated based on the current open-circuit voltage, and the power input source is controlled to execute the current charging strategy. In this way, the embodiments of the present disclosure solve a problem that the power input source type is incorrectly determined under low irradiance, which causes low charging efficiency of the power input source when the irradiance increases, realizing automatic determination of the charging control strategy, and improving charging efficiency and a utilization rate of the power input source.

### Second Embodiment

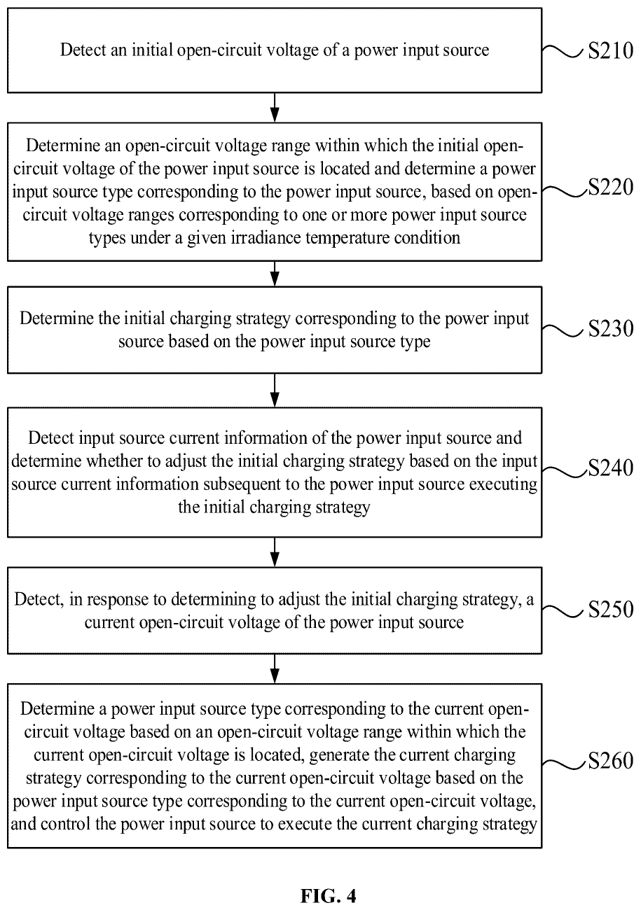

FIG. 4 is a flowchart of a charging control method according to a second embodiment of the present disclosure. In this embodiment, the operation of determining an initial charging strategy corresponding to the power input source based on the initial open-circuit voltage of the power input source is explained, which may include, for example: determining an open-circuit voltage range within which the initial open-circuit voltage of the power input source is located and determining a power input source type corresponding to the power input source, based on open-circuit voltage ranges corresponding to one or more power input source types under a given irradiance temperature condition; and determining the initial charging strategy corresponding to the power input source based on the power input source type.

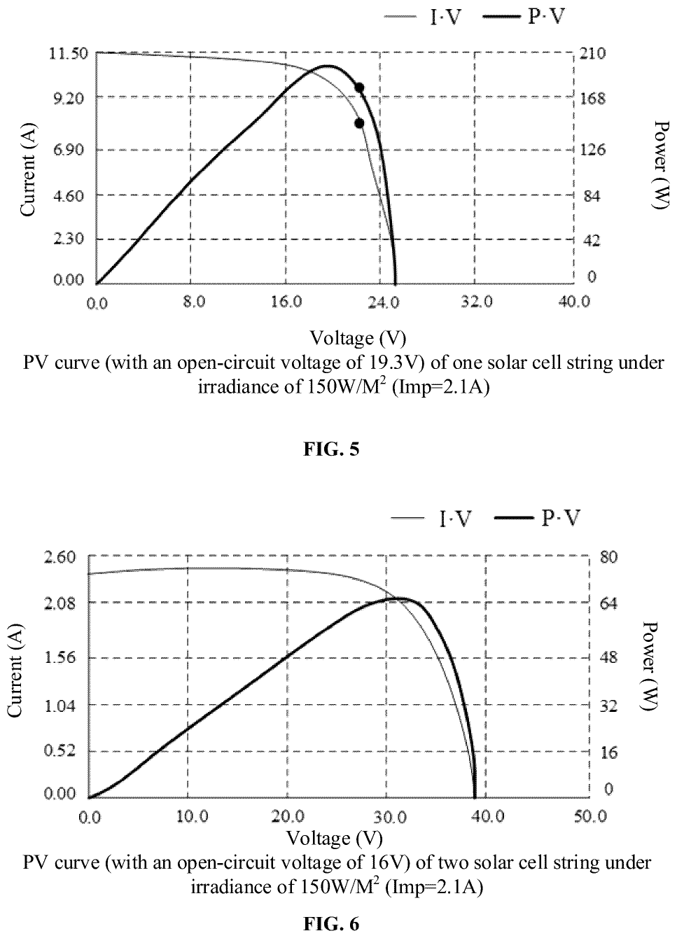

Referring to FIG. 5 and FIG. 6, in order to solve a problem that the power input source type is incorrectly determined under low irradiance, which causes low charging efficiency of the solar charging system when the irradiance increases, the present disclosure utilizes the following characteristics of a solar cell in the solar charging system, including: a stronger irradiance causes a higher output current; and a difference between open-circuit voltages outputted by different numbers of solar cell strings is significant when solar irradiance reaches a predetermined value. Reference is made to FIG. 5 and FIG. 6, which show schematic diagrams of power-voltage (PV) curves of one solar cell string (with an open-circuit voltage of 19.3V) and two solar cell strings (with an open-circuit voltage of 38.6V) under the irradiance of 150 watts per square meter (W/M²) (Imp=2.1 amps (A)). When the charging current is greater than a predetermined value, the open-circuit voltage Vin of the power input source is detected, and is used for determining the power input source type, so as to control the solar charging system to use a corresponding charging voltage to improve solar charging efficiency.

As shown in FIG. 4, the charging control method includes operations at blocks S210 to S260.

At block S210, an initial open-circuit voltage of a power input source is detected.

At block S220, based on open-circuit voltage ranges corresponding to one or more power input source types under a given irradiance temperature condition, an open-circuit voltage range within which the initial open-circuit voltage of the power input source is located is determined, and a power input source type corresponding to the power input source is determined.

At block S230, the initial charging strategy corresponding to the power input source is determined based on the power input source type.

In an embodiment, the following solar cell parameters matching the solar charging system are taken as an example. Maximum power (Pmp) is 200 watts (W), an open-circuit voltage (V0) is 24.2 V, a maximum power operation voltage (Vmp) is 19V, a maximum power operation current (Imp) is 10.53 A, a short-circuit current (Isc) is 10.8 A, and two solar cell strings may be connected in series to form a 400 W solar cell. On the above basis, it is assumed that the solar charging system supports a maximum input voltage of 60V, maximum allowable input power of 400 W, and a maximum input current of 10.53 A, and may simultaneously support charging of one solar cell string (200 W) and two solar cell strings (400 W). In addition, the solar charging system is configured such that a power input source with a voltage ranging from 11V to 35V is determined to be the one solar cell string, with a voltage of 17V used as a minimum input voltage of the one solar cells string, and that a power input source with a voltage ranging from 35V to 60V is determined to be the two solar cell strings, with a voltage of 34V used as a minimum input voltage of the two solar cell strings.

On the above basis, when the solar charging system is under low irradiance, regardless of whether the power input source is the one solar cell string or the two solar cell strings, each of their input voltage is smaller than 35V, and the power input source type corresponding to each of the one solar cell string and the two solar cell strings is determined as the one solar cell string. Moreover, the solar charging system uses 17V as a minimum charging voltage by default, i.e., the minimum charging voltage of 17V is determined as the initial charging strategy corresponding to the power input source at this time. The solar cell operates at an output voltage of 17V, and an input current of the power input source is smaller than 2.1 A, i.e., the power input source type corresponding to the power input source cannot be accurately determined at this time.

At block S240, subsequent to the power input source executing the initial charging strategy, input source current information of the power input source is detected, and it is determined whether to adjust the initial charging strategy based on the input source current information.

On the basis of the above embodiment, the input source current information includes a first charging input current and a second charging input current. The determining whether to adjust the initial charging strategy based on the input source current information includes: determining not to adjust the initial charging strategy in response to the first charging input current being greater than an input current threshold; and determining whether to adjust the initial charging strategy based on the second charging input current in response to the first charging input current being smaller than the input current threshold.

On the above basis, the power input source is controlled to execute the initial charging strategy within a predetermined time range. Thereafter, the determining whether to adjust the initial charging strategy based on the second charging input current includes: in response to the second charging input current being greater than the input current threshold, determining to adjust the initial charging strategy and controlling the power input source to be in a no-load state; and determining not to adjust the initial charging strategy in response to the second charging input current being smaller than the input current threshold.

At block S250, a current open-circuit voltage of the power input source is detected in response to determining to adjust the initial charging strategy.

At block S260, a power input source type corresponding to the current open-circuit voltage is determined based on an open-circuit voltage range within which the current open-circuit voltage is located, the current charging strategy corresponding to the current open-circuit voltage is generated based on the power input source type corresponding to the current open-circuit voltage, and the power input source is controlled to execute the current charging strategy.

On the basis of the above example, in response to the irradiance gradually increasing subsequently until the charging current of the power input source is greater than 2.1 A, it is determined to adjust the initial charging strategy. The solar charging system stops charging and re-determines the open-circuit voltage of each power input source.

It can be understood that at this time, since the irradiance reaches such a value that the open-circuit voltage of the solar cell rise high enough to distinguish the one solar cell string from the two solar cell strings, the solar charging system may accurately determine the number of strings of the solar cell panels, i.e., in response to the open-circuit voltage of the power input source having the power input source type of the one solar cell string being within a voltage range from 11V to 35V, the power input source having the determined power input source type of the one solar cell string may operate at 17V for charging, i.e., executing the current charging strategy of using the voltage of 17V as the minimum input voltage of the one solar cell string. In response to an open-circuit voltage of the power input source having the power input source type of the two solar cell strings being in a voltage range from 35V to 60V, the power input source having the determined power input source type of the two solar cell strings may operate at 34V for charging, i.e., executing the current charging strategy of using the voltage of 34V as the minimum input voltage of the two solar cell strings. Similarly, the corresponding current charging strategy currently determined is executed for each power input source type. On this basis, charging strategy adjustment is performed on all power input sources in the solar charging system respectively based on the power input source type, causing each power input source in the solar charging system to perform a charging operation at the minimum input voltage, i.e., each power input source in the solar charging system is set to perform the charging operation near a maximum power point of the power input source, to improve a utilization rate of the solar cell, which can make the utilization rate of the solar cell greater than 98%, i.e., realize an improvement in charging efficiency of a solar charging panel.

It should be noted that, in the present disclosure, in order to avoid a problem that the power input source type is inaccurately determined under low irradiance, which causes inaccurate execution of a charging strategy of the power input source subsequently, resulting in the low charging efficiency of the solar charging system, the power input source type corresponding to each power input source in the solar charging system is determined based on the open-circuit voltage, and the charging strategy corresponding to the power input source is generated based on the power input source type. That is, if the power input source type is determined accurately at the beginning, the initial charging strategy executed correspondingly and the current charging strategy subsequently determined are the same. However, since a power input source with its power input source type wrongly determined also performs the charging operation based on the initial charging strategy at the beginning, it is necessary to distinguish between the two power input sources and determine the charging strategy, i.e., the charging strategy is adjusted. When determination of the power input source type is inaccurate based on the initial open-circuit voltage at the beginning, the initial charging strategy executed correspondingly is different from the current charging strategy subsequently determined. In this case, the charging strategy of the power input source needs to be adjusted to obtain the current charging strategy.

In an embodiment, on the basis of the above example, the power input source types corresponding to the one solar cell string and two solar cell strings are determined as the one solar cell string, and the minimum charging voltage of 17V is taken as the determined initial charging strategy corresponding to the power input source at this time, i.e., the initial charging strategy determined for the one solar cell string and two solar cell strings is to perform the charging operation with the minimum charging voltage of 17V. When the power input source type is determined, it is distinguished that there are two power input source types actually, i.e., the one solar cell string and two solar cell strings. At this time, the current charging strategy for the power input source with the power input source type being determined as the one solar cell string is to perform the charging operation with the minimum charging voltage of 17V. That is, although the charging strategy is adjusted, the current charging strategy is actually the same as the initial charging strategy. The current charging strategy for the power input source with the power input source type being determined as the two solar cell strings is to perform the charging operation with the minimum charging voltage of 34V. That is, after the charging strategy is adjusted, the current charging strategy is different from the initial charging strategy.

On the basis of the above embodiment, after the current open-circuit voltage of the power input source is detected, the method further includes: re-detecting an updated open-circuit voltage of the power input source in response to the current open-circuit voltage being not within an open-circuit voltage range corresponding to any one of one or more power input source types under a given irradiance temperature condition.

It is known that a relationship between a current and voltage of the solar cell is completely different from a relationship between a current and voltage of a traditional energy storage battery. An output voltage and a corresponding current of the solar cell change with the irradiance or temperature. Usually, the solar cell has a low output voltage and provides a small current under low irradiance. After the irradiance reaches a predetermined level, the output voltage rises to a relatively high range, and the current gradually increases as the irradiance increases. With the technical solution of the embodiments of the present disclosure, the solar charging system solves the problem that the power input source type is inaccurately determined under low irradiance, and after the irradiance increases, the charging efficiency of the solar charging panel is improved, avoiding resource waste. Meanwhile, the solar charging system has a function of automatically determining the power input source type, improving the charging control capability of the solar charging system and enhancing user experience without any change in hardware, which reduces the costs.

### Third Embodiment

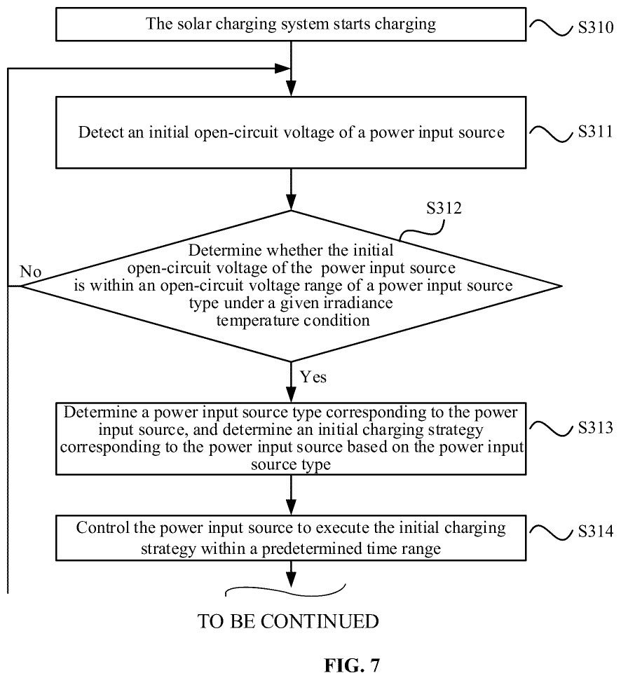

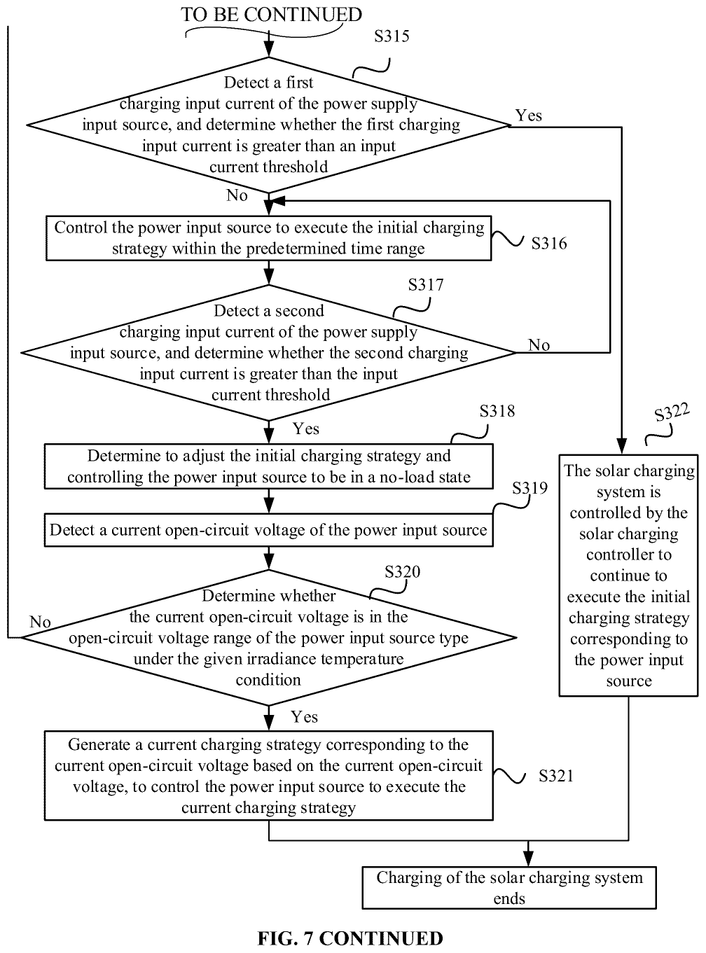

FIG. 7 is a flowchart of a charging control method according to a third embodiment of the present disclosure. As shown in FIG. 7, the charging control method includes operations at blocks S310 to S322.

At block S310, the solar charging system starts charging.

At block S311, for each of the at least one power input source, an initial open-circuit voltage of the power input source is detected.

At block S312, it is determined whether the initial open-circuit voltage of the power input source is within an open-circuit voltage range corresponding to a power input source type under a given irradiance temperature condition. In response to the initial open-circuit voltage of the power input source being within the open-circuit voltage range corresponding to the power input source type under the given irradiance temperature condition, an operation at block S313 is executed. In response to the initial open-circuit voltage of the power input source being not within the open-circuit voltage range corresponding to the power input source type under the given irradiance temperature condition, the operation at block S311 is executed.

At block S313, a power input source type corresponding to the power input source is determined, and an initial charging strategy corresponding to the power input source is determined based on the power input source type.

In an embodiment, as an example, V1, V2, . . . , Vn, and Vn+1 are predetermined voltages of the solar charging system. A first power input source, a second power input source, . . . , and a Nth power input source are power input sources of different power input source types. An open-circuit voltage range of the power input source of each power input source type under the given irradiance temperature condition may be set as follows. A voltage range from V1 to V2 is set as the open-circuit voltage range of the first power input source under the given irradiance temperature condition. A voltage range from V2 to V3 is set as the open-circuit voltage range of the second power input source under the given irradiance temperature condition. Analogously, a voltage range from Vn to Vn+1 is set as the open-circuit voltage range of the Nth power input source under the given irradiance temperature condition.

On the above basis, it is assumed that the initial open-circuit voltage of the power input source is Vin, in response to the initial open-circuit voltage Vin being in the voltage range from V1 to V2, the power input source type corresponding to the power input source is the first power input source, i.e., the power input source executes an initial charging strategy corresponding to the first voltage input source. In response to the initial open-circuit voltage Vin being in the voltage range from V2 to V3, the power input source type corresponding to the power input source is the second power input source, i.e., the power input source executes an initial charging strategy corresponding to the second voltage input source. Analogously, in response to the initial open-circuit voltage Vin being in the voltage range from Vn to Vn+1, the power input source type corresponding to the power input source is the Nth power input source, i.e., the power input source executes an initial charging strategy corresponding to the Nth voltage input source.

At block S314, the power input source is controlled to execute the initial charging strategy within a predetermined time range.

At block S315, a first charging input current of the power input source is detected, and it is determined whether the first charging input current is greater than an input current threshold. In response the first charging input current being greater than the input current threshold, an operation at block S322 is executed. In response to the first charging input current being smaller than or equal to the input current threshold, an operation at block S316 is executed.

At block S316, the power input source is controlled to execute the initial charging strategy within the predetermined time range.

At block S317, a second charging input current of the power input source is detected, and it is determined whether the second charging input current is greater than the input current threshold. In response the second charging input current being greater than the input current threshold, an operation at block S318 is executed. In response to the second charging input current being smaller than or equal to the input current threshold, the operation at block S316 is executed.

At block S318, it is determined to adjust the initial charging strategy, and the power input source is controlled to be in a no-load state.

At block S319, the current open-circuit voltage of the power input source is detected.

At block S320, it is determined whether the current open-circuit voltage is within an open-circuit voltage range corresponding to any one of one or more power input source types under a given irradiance temperature condition. In response to the current open-circuit voltage being within the open-circuit voltage range corresponding to any one of the one or more power input source types under the given irradiance temperature condition, an operation at block S321 is executed. In response to the current open-circuit voltage being not within the open-circuit voltage range corresponding to any one of the one or more power input source types under the given irradiance temperature condition, the operation at block S311 is executed.

In an embodiment, in response to the current open-circuit voltage being not within the open-circuit voltage range corresponding to any one of the one or more power input source types under the given irradiance temperature condition, an updated open-circuit voltage of the power input source is re-detected.

At block S321, a current charging strategy corresponding to the current open-circuit voltage is generated based on the current open-circuit voltage, and the power input source is controlled to execute the current charging strategy.

On the basis of the above example, similarly, the current charging strategy corresponding to the current open-circuit voltage is determined. It is assumed that the current open-circuit voltage of the power input source is Vin1, in response to the initial open-circuit voltage Vin1 being within the voltage range from V1 to V2, the power input source type corresponding to the power input source is the first power input source, i.e., the power input source executes a current charging strategy corresponding to the first voltage input source. In response to the current open circuit voltage Vin1 being within the voltage range from V2 to V3, the power input source type corresponding to the power input source is the second power input source, i.e., the power input source executes a current charging strategy corresponding to the second voltage input source. Analogously, in response to the current open-circuit voltage Vin1 being within the voltage range from Vn to Vn+1, the power input source type corresponding to the power input source is the Nth power input source, i.e., the power input source executes a current charging strategy corresponding to the Nth voltage input source.

At block S322, the solar charging system is controlled by the solar charging controller to continue to execute the initial charging strategy corresponding to the power input source.

### Fourth Embodiment

FIG. 8 is a schematic structural diagram of a charging control apparatus according to a fourth embodiment of the present disclosure. As shown in FIG. 8, the charging control apparatus includes: an initial charging strategy determination module 410 configured to detect an initial open-circuit voltage of a power input source, and determine an initial charging strategy corresponding to the power input source based on the initial open-circuit voltage of the power input source; an initial charging strategy adjustment module 420 configured to detect, subsequent to the power input source executing the initial charging strategy, input source current information of the power input source and determine whether to adjust the initial charging strategy based on the input source current information; and a current charging strategy execution module 430 configured to detect, in response to determining to adjust the initial charging strategy, a current open-circuit voltage of the power input source, generate a current charging strategy corresponding to the current open-circuit voltage based on the current open-circuit voltage, and control the power input source to execute the current charging strategy.

In an embodiment, the determining the initial charging strategy corresponding to the power input source based on the initial open-circuit voltage of the power input source includes: determining an open-circuit voltage range within which the initial open-circuit voltage of the power input source is located and determining a power input source type corresponding to the power input source, based on open-circuit voltage ranges corresponding to one or more power input source types under a given irradiance temperature condition; and determining the initial charging strategy corresponding to the power input source based on the power input source type.

In an embodiment, the input source current information includes: a first charging input current and a second charging input current; and the determining whether to adjust the initial charging strategy based on the input source current information includes: determining not to adjust the initial charging strategy in response to the first charging input current being greater than an input current threshold; and determining whether to adjust the initial charging strategy based on the second charging input current in response to the first charging input current being smaller than the input current threshold.

In an embodiment, the determining whether to adjust the initial charging strategy based on the second charging input current includes: in response to the second charging input current being greater than the input current threshold, determining to adjust the initial charging strategy and controlling the power input source to be in a no-load state; and determining not to adjust the initial charging strategy in response to the second charging input current being smaller than the input current threshold.

In an embodiment, the charging control apparatus further includes: an initial charging strategy execution module configured to control the power input source to execute the initial charging strategy within a predetermined time range.

In an embodiment, the generating the current charging strategy corresponding to the current open-circuit voltage based on the current open-circuit voltage includes: determining a power input source type corresponding to the current open-circuit voltage based on an open-circuit voltage range within which the current open-circuit voltage is located, and generating the current charging strategy corresponding to the current open-circuit voltage based on the power input source type corresponding to the current open-circuit voltage.

Optionally, the charging control apparatus further includes: an updated open-circuit voltage determination module configured to re-detect an updated open-circuit voltage of the power input source in response to the current open-circuit voltage being not within an open-circuit voltage range corresponding to any one of one or more power input source types under a given irradiance temperature condition.

The charging control apparatus provided in the embodiments of the present disclosure may execute the charging control method provided in any embodiment of the present disclosure, and have functional modules and beneficial effects corresponding to the execution of the charging control method.

### Fifth Embodiment

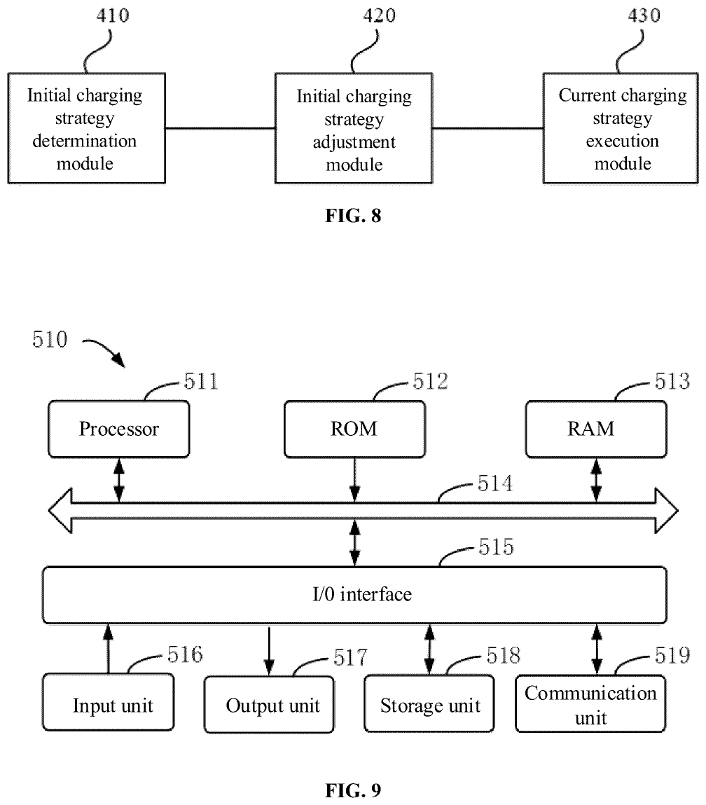

FIG. 9 shows a schematic structural diagram of a solar charging controller 510 that may be used to implement the embodiments of the present disclosure. As shown in FIG. 9, the solar charging controller 510 includes at least one processor 511, and a memory in a communication connection with the at least one processor 511, such as a Read Only Memory (ROM) 512 and a Random Access Memory (RAM) 513. The memory stores a computer program executable by the at least one processor. The processor 511 may execute a variety of appropriate actions and processes based on a computer program stored in the ROM 512 or loaded from a storage unit 518 into the RAM 513. In the RAM 513, various programs and data required for operation of the solar charging controller 510 may also be stored. The processor 511, the ROM 512, and the RAM 513 are connected to each other via a bus 514. An Input/Output (I/O) interface 515 is also connected to the bus 514.

A plurality of components in the solar charging controller 510 are connected to the I/O interface 515 and include: an input unit 516, such as a keyboard and mouse; an output unit 517, such as various types of displays and speakers; a storage unit 518, such as a disk and optical disk; and a communication unit 519, such as a network card, modem, and wireless communication transceiver. The communication unit 519 allows the solar charging controller 510 to exchange information/data with other devices via a computer network such as the Internet and/or various telecommunication networks.

The processor 511 may be a variety of general purpose and/or dedicated processing components with processing and computing capabilities. Examples of the processor 511 may include a Central Processing Unit (CPU), a Graphic Processing Unit (GPU), various dedicated Artificial Intelligence (AI) computing chips, various processors running machine learning modeling algorithms, a Digital Signal Processing (DSP), and any appropriate processors, controllers, and microcontrollers. The processor 511 executes the various methods and processes described above, such as the charging control method.

In some embodiments, the charging control method may be implemented as a computer program tangibly contained in a computer-readable storage medium, such as the storage unit 518. In some embodiments, the computer program may be partially or fully loaded and/or installed onto the solar charging controller 510 via the ROM 512 and/or the communication unit 519. When the computer program is loaded into the RAM 513 and executed by processor 511, one or more operations at blocks of the charging control method described above may be executed. Alternatively, in other embodiments, the processor 511 may be configured to execute the charging control method in other appropriate manners (like by means of firmware).

Various implementations of the systems and techniques described above herein may be realized in a digital electronic circuit system, an integrated circuit system, a Field-Programmable Gate Array (FPGA), an Application Specific Integrated Circuit (ASIC), Application Specific Standard Parts (ASSPs), a System on Chip (SOC), a Complex Programmable Logic Device (CPLD), computer hardware, firmware, software, and/or combinations thereof. These various implementations may include: being implemented in one or more computer programs that may be executed and/or interpreted on a programmable system including at least one programmable processor. The programmable processor may be a dedicated or general-purpose programmable processor, may receive data and instructions from a storage system, at least one input apparatus, and at least one output apparatus, and transmit the data and instructions to the storage system, the at least one input apparatus, and the at least one output apparatus.

Computer programs for implementing the methods of the present disclosure may be written in any combination of one or more programming languages. These computer programs may be provided to a processor of a general-purpose computer, a special-purpose computer, or other programmable data processing apparatus, such that the computer program, when executed by the processor, causes the functions/operations specified in the flowchart and/or the block diagram to be implemented. The computer program may be executed entirely or partially on the machine, or as a stand-alone software package partially executed on the machine and partially executed on a remote machine or entirely on the remote machine or server.

In the context of the present disclosure, the computer-readable storage medium may be a tangible medium that may contain or store a computer program for use by or in conjunction with an instruction-execution system, apparatus, or device. The computer-readable storage medium may include an electronic, magnetic, optical, electromagnetic, infrared, or semiconductor system, apparatus, or device, or a suitable combination of the foregoing. Alternatively, the computer-readable storage medium may be a machine-readable signaling medium. Examples of a machine-readable storage medium may include an electrical connection having one or more wires, a portable computer disk, a hard disk, a Random Access Memory (RAM), a Read Only Memory (ROM), an Erasable Programmable Read Only Memory (EPROM) or flash memory, an optical fiber, a Compact Disc Read Only Memory (CD-ROM), an optical storage device, a magnetic storage device, or a suitable combination thereof.

In order to provide interaction with a user, the systems and techniques described herein may be implemented on the solar charging controller. The solar charging controller has: a display apparatus (such as a Cathode Ray Tube (CRT) or Liquid Crystal Display (LCD) or monitor) for displaying information to the user, and a keyboard and pointing apparatus (such as a mouse or trackball). The user may provide input to the solar charging controller through the keyboard and pointing apparatus. Other types of apparatuses may also be configured to provide the interaction with the user. For example, feedback provided to the user may be any form of sensory feedback (such as visual feedback, auditory feedback, or haptic feedback). Moreover, the input from the user may be received in any form (including acoustic input, voice input, or haptic input).

The systems and techniques described herein may be implemented in a computing system including a back-end component (such as a data server), or a computing system including a middleware component (such as an application server), or a computing system including a front-end component (such as a user computer with a graphical user interface or a web browser, through which the user can interact with implementations of the system and techniques described herein), or in a computing system including any combination of such the back-end component, middleware component, or front-end component. The components of the system may be interconnected through digital data communications (such as a communications network) in any form or medium. Examples of the communication network include: a Local Area Network (LAN), a Wide Area Network (WAN), a blockchain network, and the Internet.

The computing system may include a client and a server. The client and server are generally far away from one another and typically interact with each other over the communication network. A relationship between the client and the server is created by computer programs that run on corresponding computers and have a client-server relationship from one another. The server may be a cloud server, also known as a cloud computing server or cloud host, and is a host product in a cloud computing service system, to solve defects of difficult management and weak business scalability existing in traditional physical host and VPS services.

It should be understood that blocks may be reordered, added or removed using various forms of processes as shown above. For example, the various blocks documented in the present disclosure may be performed in parallel or sequentially or in a different order, as long as the desired result of the technical solutions of the present disclosure can be achieved.

What is claimed is:

1. A charging control method, comprising:
detecting an initial open-circuit voltage of a power input source, and determining an initial charging strategy corresponding to the power input source based on the initial open-circuit voltage of the power input source;
detecting, subsequent to the power input source executing the initial charging strategy, input source current information of the power input source and determining whether to adjust the initial charging strategy based on the input source current information; and
detecting, in response to determining to adjust the initial charging strategy, a current open-circuit voltage of the power input source, generating a current charging strategy corresponding to the current open-circuit voltage based on the current open-circuit voltage, and controlling the power input source to execute the current charging strategy.

2. The charging control method according to claim 1, wherein said determining the initial charging strategy corresponding to the power input source based on the initial open-circuit voltage of the power input source comprises:
determining an open-circuit voltage range within which the initial open-circuit voltage of the power input source is located and determining a power input source type corresponding to the power input source, based on open-circuit voltage ranges corresponding to one or more power input source types under a given irradiance temperature condition; and
determining the initial charging strategy corresponding to the power input source based on the power input source type.

3. The charging control method according to claim 1, wherein the input source current information comprises: a first charging input current and a second charging input current; and
said determining whether to adjust the initial charging strategy based on the input source current information comprises:
determining not to adjust the initial charging strategy in response to the first charging input current being greater than an input current threshold; and
determining whether to adjust the initial charging strategy based on the second charging input current in response to the first charging input current being smaller than the input current threshold.

4. The charging control method according to claim 3, wherein said determining whether to adjust the initial charging strategy based on the second charging input current comprises:
in response to the second charging input current being greater than the input current threshold, determining to adjust the initial charging strategy and controlling the power input source to be in a no-load state; and
determining not to adjust the initial charging strategy in response to the second charging input current being smaller than the input current threshold.

5. The charging control method according to claim 3, further comprising, prior to said determining whether to adjust the initial charging strategy based on the second charging input current:
controlling the power input source to execute the initial charging strategy within a predetermined time range.

6. The charging control method according to claim 1, wherein said generating the current charging strategy corresponding to the current open-circuit voltage based on the current open-circuit voltage comprises:
determining a power input source type corresponding to the current open-circuit voltage based on an open-circuit voltage range within which the current open-circuit voltage is located, and generating the current charging strategy corresponding to the current open-circuit voltage based on the power input source type corresponding to the current open-circuit voltage.

7. The charging control method according to claim 6, further comprising, subsequent to detecting the current open-circuit voltage of the power input source:
re-detecting an updated open-circuit voltage of the power input source in response to the current open-circuit voltage being not within an open-circuit voltage range corresponding to any one of one or more power input source types under a given irradiance temperature condition.

8. The charging control method according to claim 2, wherein said determining the initial charging strategy corresponding to the power input source according to the power input source type comprises:
determining a minimum input voltage corresponding to the power input source type, the charging strategy comprising the power input source performing charging at the minimum input voltage; or
said generating the current charging strategy corresponding to the current open-circuit voltage based on the power input source type corresponding to the current open-circuit voltage comprises:
determining a minimum input voltage corresponding to the power input source type corresponding to the current open-circuit voltage, the current charging strategy comprising the power input source performing charging at the minimum input voltage.

9. The method according to claim 3, wherein said determining not to adjust the initial charging strategy in response to the first charging input current being greater than the input current threshold and said determining whether to adjust the initial charging strategy based on the second charging input current in response to the first charging input current being smaller than the input current threshold comprises:
controlling the power input source to execute the initial charging strategy, and detecting the first charging input current of the power input source;
determining not to adjust the initial charging strategy in response to the first charging input current being greater than the input current threshold; and
in response to the first charging input current being smaller than the input current threshold, controlling the power input source to execute the initial charging strategy, detecting the second charging input current of the power input source, and determining whether to adjust the initial charging strategy based on the second charging input current.

10. The charging control method according to claim 2, wherein open-circuit voltage ranges corresponding to the one or more power input source types do not overlap with each other.

11. A solar charging controller, comprising:
at least one processor; and
a memory in a communication connection with the at least one processor,
wherein the memory stores a computer program executable by the at least one processor, the computer program being executed by the at least one processor to enable the at least one processor to perform a charging control method, the charging control method comprising:
detecting an initial open-circuit voltage of a power input source, and determining an initial charging strategy corresponding to the power input source based on the initial open-circuit voltage of the power input source;
detecting, subsequent to the power input source executing the initial charging strategy, input source current information of the power input source and determining whether to adjust the initial charging strategy based on the input source current information; and
detecting, in response to determining to adjust the initial charging strategy, a current open-circuit voltage of the power input source, generating a current charging strategy corresponding to the current open-circuit voltage based on the current open-circuit voltage, and controlling the power input source to execute the current charging strategy.

12. The solar charging controller according to claim 11, wherein said determining the initial charging strategy corresponding to the power input source based on the initial open-circuit voltage of the power input source comprises:
determining an open-circuit voltage range within which the initial open-circuit voltage of the power input source is located and determining a power input source type corresponding to the power input source, based on open-circuit voltage ranges corresponding to one or more power input source types under a given irradiance temperature condition; and
determining the initial charging strategy corresponding to the power input source based on the power input source type.

13. The solar charging controller according to claim 11, wherein:
the input source current information comprises: a first charging input current and a second charging input current; and
said determining whether to adjust the initial charging strategy based on the input source current information comprises:
determining not to adjust the initial charging strategy in response to the first charging input current being greater than an input current threshold; and
determining whether to adjust the initial charging strategy based on the second charging input current in response to the first charging input current being smaller than the input current threshold.

14. The solar charging controller according to claim 13, wherein said determining whether to adjust the initial charging strategy based on the second charging input current comprises:
in response to the second charging input current being greater than the input current threshold, determining to adjust the initial charging strategy and controlling the power input source to be in a no-load state; and
determining not to adjust the initial charging strategy in response to the second charging input current being smaller than the input current threshold.

15. The solar charging controller according to claim 13, wherein the charging control method further comprises, prior to said determining whether to adjust the initial charging strategy based on the second charging input current:
controlling the power input source to execute the initial charging strategy within a predetermined time range.

16. The solar charging controller according to claim 11, wherein said generating the current charging strategy corresponding to the current open-circuit voltage based on the current open-circuit voltage comprises:
determining a power input source type corresponding to the current open-circuit voltage based on an open-circuit voltage range within which the current open-circuit voltage is located, and generating the current charging strategy corresponding to the current open-circuit voltage based on the power input source type corresponding to the current open-circuit voltage.

17. The solar charging controller according to claim 16, wherein the charging control method further comprises, subsequent to detecting the current open-circuit voltage of the power input source:
re-detecting an updated open-circuit voltage of the power input source in response to the current open-circuit voltage being not within an open-circuit voltage range corresponding to any one of one or more power input source types under a given irradiance temperature condition.

18. The solar charging controller according to claim 12, wherein:
said determining the initial charging strategy corresponding to the power input source in according to the power input source type comprises:
determining a minimum input voltage corresponding to the power input source type, the charging strategy comprising the power input source performing charging at the minimum input voltage; or
said generating the current charging strategy corresponding to the current open-circuit voltage based on the power input source type corresponding to the current open-circuit voltage comprises:
determining a minimum input voltage corresponding to the power input source type corresponding to the current open-circuit voltage, the current charging strategy comprising the power input source performing charging at the minimum input voltage.

19. The solar charging controller according to claim 13, wherein said determining not to adjust the initial charging strategy in response to the first charging input current being greater than the input current threshold and said determining whether to adjust the initial charging strategy based on the second charging input current in response to the first charging input current being smaller than the input current threshold comprises:
controlling the power input source to execute the initial charging strategy, and detecting the first charging input current of the power input source;
determining not to adjust the initial charging strategy in response to the first charging input current being greater than the input current threshold; and
in response to the first charging input current being smaller than the input current threshold, controlling the power input source to execute the initial charging strategy, detecting the second charging input current of the power input source, and determining whether to adjust the initial charging strategy based on the second charging input current.

20. A non-transitory computer-readable storage medium, storing a computer instruction configured to cause a processor to perform a charging control method, the charging control method comprising:
detecting an initial open-circuit voltage of a power input source, and determining an initial charging strategy corresponding to the power input source based on the initial open-circuit voltage corresponding to the power input source;
detecting, subsequent to the power input source executing the initial charging strategy, input source current information of the power input source and determining whether to adjust the initial charging strategy based on the input source current information; and
detecting, in response to determining to adjust the initial charging strategy, a current open-circuit voltage of the power input source, generating a current charging strategy corresponding to the current open-circuit voltage based on the current open-circuit voltage, and controlling the power input source to execute the current charging strategy.
